(19) United States
(12) Patent Application Publication
(10) Pub. No.: US 2010/0327194 A1
(43) Pub. Date: Dec. 30, 2010

(54) MULTI-BIT USE OF A STANDARD OPTOCOUPLER

(76) Inventors: Jian Xu, Windsor (CA); John Gerard Finch, Livonia, MI (US)

Correspondence Address: Carlson, Gaskey & Olds/Masco Corporation, 400 West Maple Road, Suite 350, Birmingham, MI, 48009, US

(21) Appl. No.: 12/492,378

(22) Filed: Jun. 26, 2009

(51) Int. Cl. G02B 27/00

(52) U.S. Cl. 250/551

(57) ABSTRACT

A method of indicating multi-bit values using a single optocoupler indicates a first multi-bit value in response to a first range of optocoupler output voltages, and indicates a second multi-bit value in response to a second range of optocoupler output voltages. The first range is different from the second range.

### BACKGROUND OF THE INVENTION

This application relates to optocouplers, and more particularly to a method of indicating multi-bit values using a single optocoupler.

An optocoupler is a device that uses a short optical transmission path to transfer a signal between elements of a circuit, while keeping the circuit elements electrically isolated. One optocoupler configuration includes a photo diode that emits light that causes a photo transistor to turn ON and permit a flow of current, yielding an output voltage. Thus, the photo diode is able to control the photo transistor while remaining electrically isolated from the photo transistor.

Optocouplers have wide tolerance ranges, such that an input current to an optocoupler may yield a wide range of output voltages. As a result, optocouplers used for data transmission are only used to pass single bit values (for example, a logic 0 is OFF, and a logic 1 is ON). Transmitting multi-bit data has required an optocoupler for each bit of data.

### SUMMARY OF THE INVENTION

A method of indicating multi-bit values using a single optocoupler indicates a first multi-bit value in response to a first range of optocoupler output voltages, and indicates a second multi-bit value in response to a second range of optocoupler output voltages. The first range is different from the second range.

A system for indicating multi-bit values using a single optocoupler includes an optocoupler, a controller, and an analog to digital converter. The controller is operable to inject specific input currents into the optocoupler to yield an output voltage within one of a plurality of predefined ranges. The analog to digital converter is coupled to the optocoupler and is operable to indicate a multi-bit value in response to an output voltage of the optocoupler falling within one of the plurality of predefined ranges. Each of the plurality of predefined ranges is assigned a multi-bit value.

These and other features of the present invention can be best understood from the following specification and drawings, the following of which is a brief description.

### BRIEF DESCRIPTION OF THE DRAWINGS

FIG. 1 schematically illustrates an example optocoupler.

FIG. 2 schematically illustrates a table of example input currents and output voltage ranges corresponding to an optocoupler having a current transfer ratio of 50%-200%.

FIG. 3 schematically illustrates a graph of example input currents and output voltage ranges corresponding to an optocoupler having a current transfer ratio of 50%-200%.

### DETAILED DESCRIPTION OF THE PREFERRED EMBODIMENT

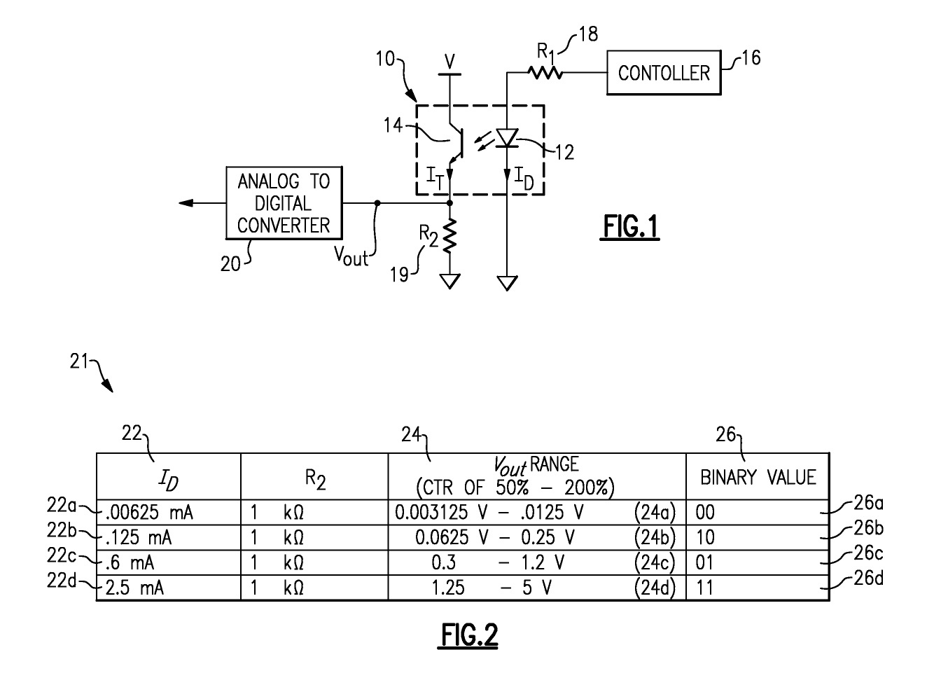

FIG. 1 schematically illustrates an example optocoupler 10 that includes a photo diode 12 and a photo transistor 14 that are electrically isolated from each other. A controller 16 controls a diode current I_{D} that flows through the photo diode 12 and causes the photo diode 12 to emit light. The emitted light causes photo transistor 14 to turn ON to allow transistor current I_{T} to flow, yielding output voltage Vₒᵤₜ. Resistor 18 (“R₁”) is coupled to the controller 16 and the photo diode 12. Resistor 19 (“R₂”) is coupled to the photo transistor 14 and is coupled to an analog to digital converter 20. The analog to digital converter 20 is operable to convert the analog output voltage Vₒᵤₜ into a digital signal readable by a microprocessor (not shown).

The magnitude of the transistor current I_{T} is governed by equation #1 below, and the magnitude of output voltage Vₒᵤₜ is governed by equation #2 below.

I_{T}=I_{D}*CTR equation #1

where I_{T} is the transistor current;

I_{D} is the diode current; and

CTR is an optocoupler current transfer ratio (“CTR”) representing a ratio of the output current(“I_{T}”) to the input current (“I_{D}”).

Vₒᵤₜ=I_{T}*R₂ equation #2

FIG. 2 schematically illustrates a table 21 of example input currents 22a-d, example output voltage ranges 24a-d, and example binary value assignments 26 for an optocoupler having a CTR of 50%-200%, assuming R₂ is 1 kΩ. As shown in the table 21, by injecting a specific diode current I_{D} into the optocoupler 10, a specific voltage range can be achieved. By assigning a different multi-bit value 26 to each range 24a-d, a single optocoupler 10 can be used to express a plurality of multi-bit values 26a-d, even if the optocoupler has a widely varying CTR (e.g. 50%-200%).

In the Example of FIG. 2, range 24a corresponds to multi-bit value 26a (“00”), range 24b corresponds to multi-bit value 26b (“01”), range 24c corresponds to multi-bit value 26c (“10”), and range 24d corresponds to multi-bit value 26d (“11”). The multi-bit values 26 can be used to indicate a state of a system, such as a lighting system. In one example multi-bit value 26a (“00”) corresponds to no fault, multi-bit value 26b (“01”) corresponds to an over-temperature fault, multi-bit value 26c (“10”) corresponds to an over-current fault, and multi-bit value 26d (“11”) corresponds to a hardware fault (e.g. damaged MOSFET). Of course, the multi-bit values 26 could be used to indicate other states, or even other pieces of information that are not states.

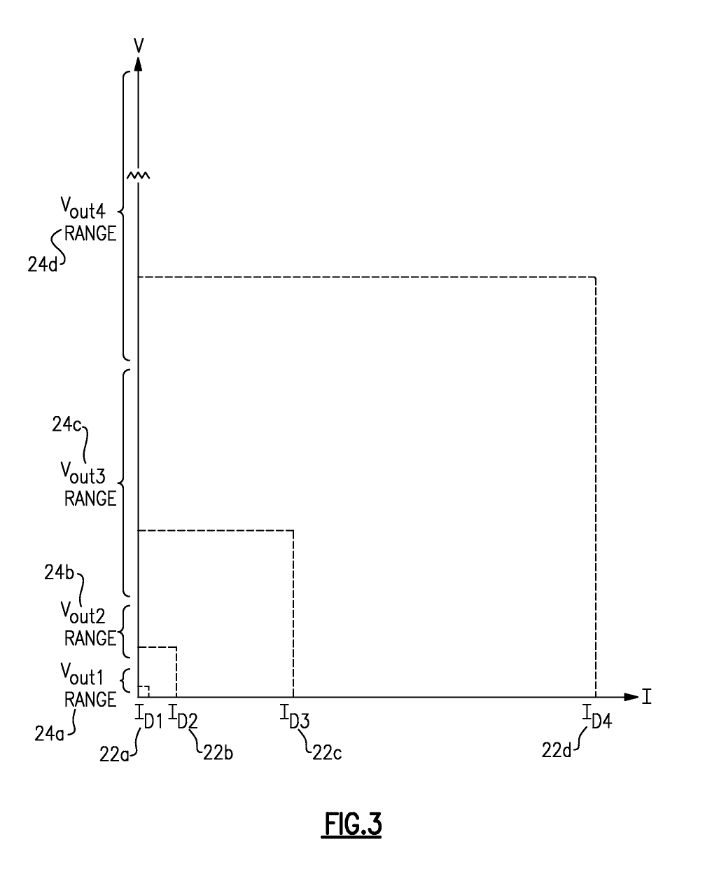

FIG. 3 schematically illustrates a graph of example input currents and output voltage ranges corresponding to an optocoupler having a CTR of 50%-200%. In the example of the table 21 of FIG. 2 and the graph of FIG. 3, each of the voltage ranges 24a-d are non-overlapping, and are spaced apart by a minimum voltage range spacing. In the example of the table 21, the minimum voltage range spacing is 0.05 V. Of course the values of FIG. 2 and graph of FIG. 3 are only exemplary, and other current transfer ratios, current values, resistor values, and voltage separation ranges could be used. If the voltage ranges did overlap, statistical analysis techniques according to known methods could be used to determine which voltage range a given output voltage fell within.

Referring to the values from table 21 of FIG. 2, the first current 22a of 0.00625 mA yields a first voltage range 24a of 0.003125-0.0125 V (50-200% of 0.00625 mA). The second current 22b of 0.125 mA amps yields a second voltage range 24b of 0.0625-0.25 V (50-200% of 0.125). The third current 22c of 0.6 mA yields a third voltage range 24c of 0.3-1.2 V (50-200% of 16). The fourth current 22d of 2.5 mA amps yields a fourth voltage range 24d of 1.25-5 V (50-200% of 64).

Although only four voltage ranges 24a-d and four multi-bit values 26a-d have been described, it is possible that additional ranges and corresponding multi-bit values could be achieved. The maximum number of available non-overlapping ranges 24 would depends on the maximum tolerance of the CTR of a given digital optocoupler 10, and on how discretely non-overlapping ranges can be divided across the entire current range of a given optocoupler.

Although a preferred embodiment of this invention has been disclosed, a worker of ordinary skill in this art would recognize that certain modifications would come within the scope of this invention. For that reason, the following claims should be studied to determine the true scope and content of this invention.

What is claimed is:

1. A method of indicating multi-bit values using a single optocoupler, comprising:
indicating a first multi-bit value in response to a first range of optocoupler output voltages; and
indicating a second multi-bit value in response to a second range of optocoupler output voltages, the second range being different than the first range.

2. The method of claim 1, further comprising:
indicating a third multi-bit value in response to a third range of optocoupler output voltages, the third range being different from the first range and the second range.

3. The method of claim 2, further comprising:
indicating a fourth multi-bit value in response to a fourth range of optocoupler output voltages, the fourth range being different than the first range, the second range and the third range.

4. The method of claim 1, further comprising:
assigning a multi-bit value to each of the ranges of optocoupler output voltages.

5. The method of claim 1, wherein each of the ranges of optocoupler output voltages are proportional to an optocoupler input current and an optocoupler current transfer ratio.

6. The method of claim 1, wherein the second range is greater than the first range.

7. The method of claim 1, wherein each of the ranges of optocoupler output voltages are non-overlapping.

8. The method of claim 7, wherein each of the predefined ranges are spaced apart by a minimum voltage range spacing.

9. The method of claim 8, wherein the minimum voltage range spacing is at least 0.05 volts.

10. The method of claim 1, further comprising:
using at least one statistical analysis technique to determine which optocoupler output voltage range a given output voltage falls within in response to at least one of the ranges of optocoupler output voltages being overlapping.

11. A system for indicating multi-bit values using a single optocoupler, comprising:
an optocoupler;
a controller operable to inject specific input currents into the optocoupler to yield an output voltage within one of a plurality of predefined ranges; and
an analog to digital converter coupled to optocoupler and operable to indicate a multi-bit value in response to an output voltage of the optocoupler falling within one of the plurality of predefined ranges, wherein each of the plurality of predefined ranges is assigned a multi-bit value.

12. The system of claim 11, wherein each of the predefined ranges are spaced apart by a minimum voltage range spacing.

13. The system of claim 12, wherein the minimum voltage range spacing is at least 0.05 volts.

14. The method of claim 1, wherein if any of the ranges of optocoupler output voltages are overlapping, at least one statistical analysis technique is used to determine which optocoupler output voltage range a given output voltage falls within.

15. The system of claim 11, wherein the optocoupler includes a photo diode and a photo transistor that are electrically isolated from each other.

16. The system of claim 15, wherein the controller is operable to control the photo diode to emit light to selectively control a flow of current through the photo transistor.

17. The system of claim 15, further comprising:
a first resistor coupled to the controller and to the photo diode; and
a second resistor coupled to the photo transistor and to the analog to digital converter.

18. The system of claim 11, wherein a first multi-bit value corresponds to no fault, a second multi-bit value corresponds to an over-temperature fault, a third multi-bit value corresponds to an over-current fault, and a fourth multi-bit value corresponds to a hardware fault.
